(19) United States
(12) Patent Application Publication
(10) Pub. No.: US 2018/0048072 A1
(43) Pub. Date: Feb. 15, 2018

(54) ANTENNA REFLECTOR IN PARTICULAR FOR SPACECRAFT

(71) Applicant: AIRBUS SAFRAN LAUCHERS SAS, Issy-les-Moulineaux (FR)

(72) Inventors: Audrey-Marine Louis, Paris (FR); Régis Rault, Le Chesnay (FR); Frédéric Veilleraud, Bouc Bel Air (FR)

(73) Assignee: ArianeGroup SAS, Paris (FR)

(21) Appl. No.: 15/554,413

(22) PCT Filed: Mar. 8, 2016
(86) PCT No.: PCT/FR2016/000039

§ 371 Date: Aug. 29, 2017

(30) Foreign Application Priority Data
Mar. 10, 2015 (FR) 15 00456

(51) Int. Cl. H01Q 15/16; H01Q 19/10; H01Q 1/28

(52) U.S. Cl. CPC H01Q 15/16; H01Q 1/288; H01Q 19/102

(57) ABSTRACT

An antenna reflector, in particular for a spacecraft and especially for a satellite, includes a shell provided with a first surface that is reflective, and a reinforcing system this is arranged on a second surface of the shell, opposite said first surface. The antenna reflector further includes at least one structural portion having a generally circular shape.

The present invention relates to an antenna reflector, in particular for a spacecraft antenna and especially for a satellite antenna.

The present invention relates more particularly, although not exclusively, to an antenna reflector for a telecommunication satellite, in particular a reflector for an antenna of a large size. A reflector of a satellite antenna, for example, is a portion of an antenna that allows an electromagnetic wave exchanged between the satellite and the Earth to be reflected and shaped.

An antenna reflector usually comprises a rigid structure (shell) provided with a reflective surface, reflecting the electromagnetic (radio frequency) waves, and a reinforcement system provided with what is known as a rear structure, which holds the shell and connects the shell to the satellite. The shell is usually secured to the rear structure by a set of flexible fixing elements.

The rear structure of a reflector generally has an assembly of rectilinear tubes, connected to one another so as to form angles. This rear structure has a general shape of a polygon, for example a rectangle, or an assembly of polygons.

Furthermore, the shells generally have an outline that is circular or derived from a circle (such as a truncated circle), in order to optimise the radio frequency performance of the antenna.

The adjustment of the rear structure, of a polygonal type, on the shell, circular in shape, cannot be implemented optimally, in particular because:
there is a variable distance between the foot of the fixing elements and the edge of the shell, namely the length of the free edge of the shell. This is because it is not possible to accurately select the length of the free edge in order to maintain that length at an optimal value over the entire perimeter of the shell. Moreover, a free edge is necessary to allow the mechanical energy experienced at the time of launch to be dissipated. However, a free edge that is too long produces large movements of the edge of the shell, and therefore weakens the shell edge; and
a polygonal rear structure has regions of angles. These regions of angles result in concentrations of stresses, which may represent weak regions of the reflector.

Furthermore, the polygonal structure is positioned in a plane above the shell, and does not allow the parabolic general shape of the reflector to be followed. The reflector is therefore not, geometrically, very compact.

In addition, with a polygonal rear structure, the length of the fixing elements between the shell and the rear structure varies depending on their position along the length of the rear structure. As is the case for the lengths of the shell edge (or free edge), there is an optimal length for the fixing elements. This is because a fixing element that is too long is more susceptible to buckling and it reduces the mechanical strength of the fixing element (and of the reflector), and a fixing element that is too short does not allow a sufficiently high degree of flexibility between the rear structure and the shell. In addition, a fixing element that is too short results in losses of mechanical performance in the strength of the joint at the foot of the fixing element. Moreover, the use of a polygonal structure results in variations in the lengths of the fixing elements, and therefore at least some of the fixing elements have a non-optimal length.

Furthermore, the preferred positioning for a fixing element is to arrange it radially in relation to the shell. When the rear structure is polygonal, the fixing elements are not everywhere arranged radially, or it is necessary to add angle wedges between the fixing elements and the rear structure in order to ensure a radial position, which increases the mass of the reflector.

A usual antenna reflector structure comprising a shell and a polygonal rear structure (of a reinforcement system), such as those mentioned above, is therefore not optimal.

The aim of the present invention is to overcome at least some of the disadvantages mentioned above. It relates to an antenna reflector, in particular for a spacecraft and especially for a satellite, said antenna reflector comprising a shell provided with a first surface that is reflective, and a reinforcement system which is arranged on a second surface of the shell, opposite said first surface, and which comprises a structure known as a rear structure.

According to the invention, said rear structure comprises at least one structural portion with a general shape that is circular at least in part.

Thus, by virtue of the invention, the rear structure is not of the usual completely polygonal type, and comprises at least one structural portion that is circular. The use of a circular structural portion of this kind has several advantages that enable at least some of the disadvantages mentioned above to be overcome, as detailed below.

In a first embodiment, said at least one structural portion of said rear structure has a general shape that is completely circular.

In a particular variant of this first embodiment, said rear structure comprises a plurality of structural portions with general shapes that are (completely) circular, and of different diameters.

In addition, advantageously, said shell has a paraboloid structure with or without local shaping, and said at least one structural portion of said rear structure is arranged on the second surface of the shell so as to be held, by a set of fixing elements (by all the fixing elements of that set), at a substantially constant distance from said second surface, preferably corresponding to an optimal distance.

Furthermore, in a second embodiment, said at least one structural portion of said rear structure has a mixed general shape, comprising at least one polygonal portion and at least one circular portion. In a particular variant of this second embodiment, said mixed general shape is a truncated circular shape.

Furthermore, advantageously, said antenna reflector has at least some of the following features, taken individually or in combination:
it has a plurality of fixing elements arranged between the second surface of the shell and a surface facing said rear structure, said fixing elements being intended to secure the reinforcement system to the shell;
said fixing elements are arranged radially on said second surface of the shell;
said at least one structural portion of the rear structure comprises at least one torus. Advantageously, said at least one torus is produced as a single part or as a plurality of elements (or parts) assembled together;
said rear structure is made of composite material.

The present invention also relates to spacecraft, in particular a satellite, that has at least one antenna reflector as mentioned above.

The accompanying figures will give a good understanding as to how the invention may be embodied. In these figures, identical references designate similar elements.

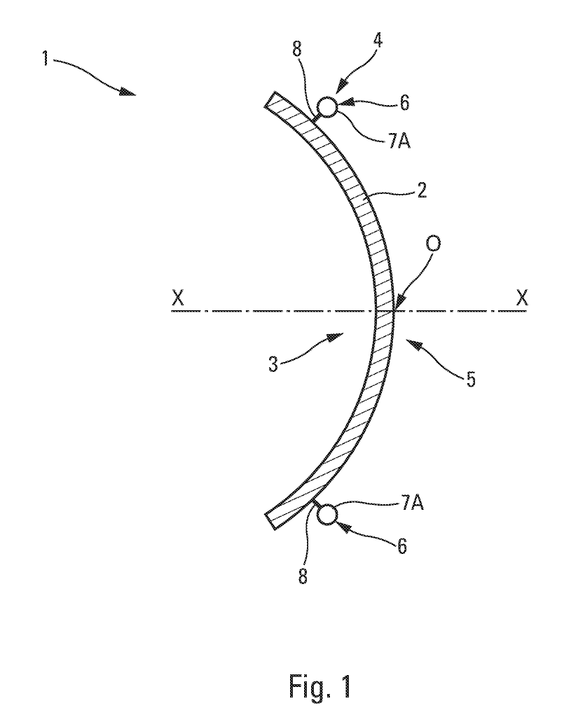

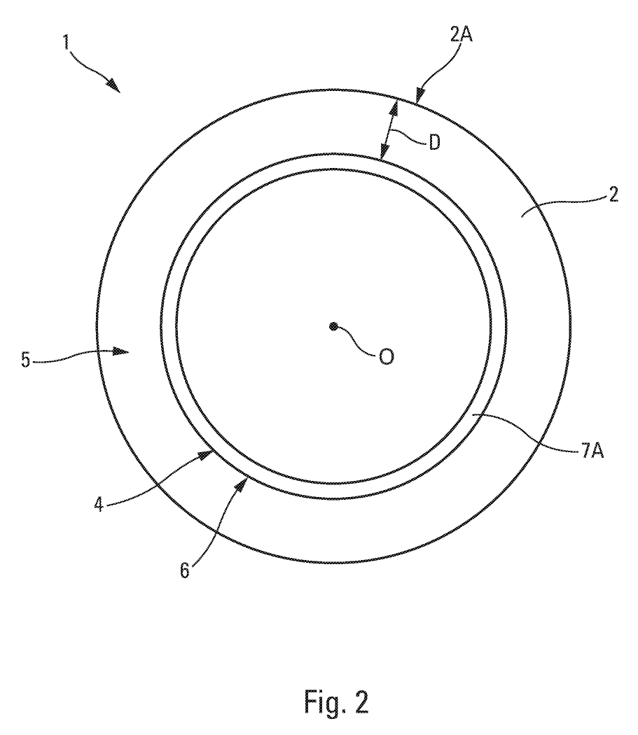

FIGS. 1 and 2 are schematic views, in cross section and in plan view respectively, of an antenna reflector illustrating the invention.

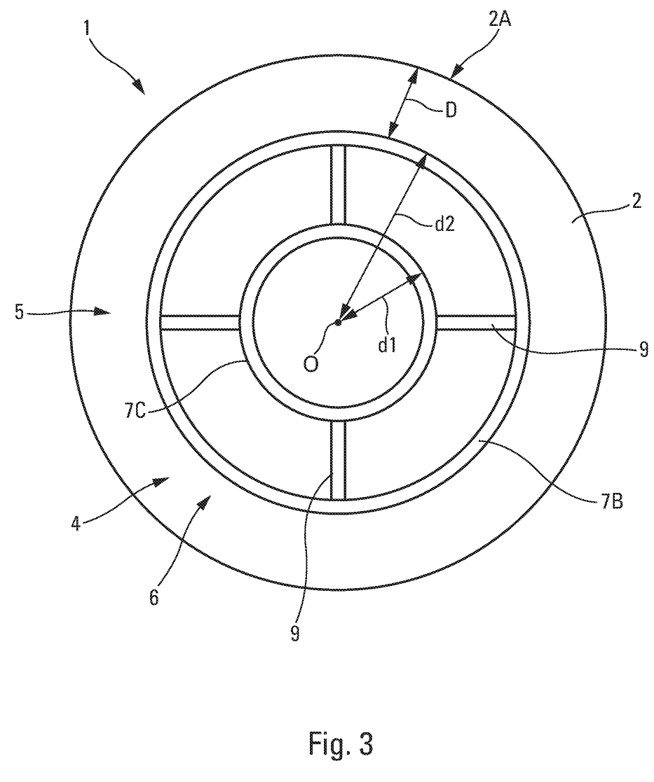

FIG. 3 is a schematic plan view of a particular embodiment of an antenna reflector provided with a rear structure comprising several concentric structural portions.

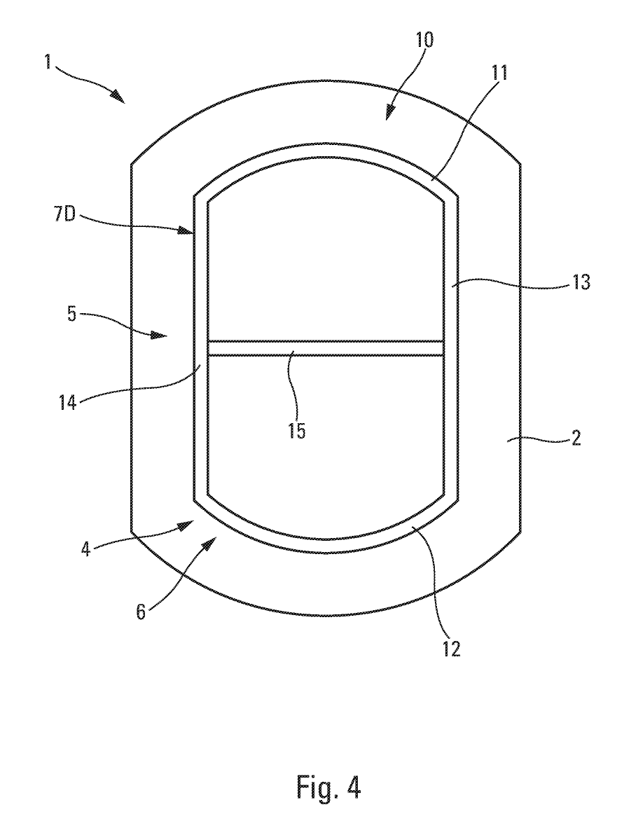

FIG. 4 is a schematic plan view of a particular embodiment of an antenna reflector with a truncated circular shape.

The antenna reflector 1 (hereinafter referred to as “reflector 1”) illustrating the invention and represented schematically in FIG. 1 is an antenna reflector, in particular for a spacecraft antenna and especially for a satellite antenna. Although not exclusively, this reflector 1 may be an antenna reflector of a telecommunication satellite, in particular an antenna of a large size, for example with a diameter of approximately two to five metres.

The description that follows applies, by way of illustration, to a satellite antenna reflector.

An antenna reflector of this kind must fulfil very rigorous specifications and must have, in particular, good mechanical resistance to the environments that exist when the satellite is launched, a precision of surface, surface stability during extreme variations in temperature such as those that occur in orbit, good mechanical strength over a wide range of temperatures, a very low weight, and a high degree of stiffness.

The reflector 1 usually comprises, as shown very schematically in FIG. 1:
a shell 2 provided with a first surface, known as a front surface 3, which is capable of reflecting electromagnetic waves; and
a reinforcement system 4 which is arranged on a second surface of the shell 2, known as the rear surface 5, which is opposite said front surface 3. This reinforcement system 4 comprises a main structure known as a rear structure 6, and also other standard elements and means (not shown) allowing, in particular, the reflector 1 to be fixed to the satellite concerned. The purpose of the reinforcement system 4 is to hold the shell 2 and to connect the shell 2 to the satellite.

In a preferred embodiment (not shown), the shell 2 of the reflector 1 comprises a composite sandwich structure comprising a honeycomb core, which is transparent to electromagnetic (radio) waves, and to which are affixed a front skin and a rear skin. Each of the skins comprises one or more than one layer of composite material with, for example, carbon fibres. Each layer may be a unidirectional layer or a woven layer. The material constituting the front skin (that is to say, the reflective front surface 3) of the shell 2 must allow electromagnetic waves to be reflected. A stacking of layers of composite material ensures good mechanical performance and a low weight. The shell may have a specific shape for each reflector concerned.

According to the invention, the rear structure 6 of the reflector 1 comprises at least one structural portion 7A, 7B, 7C, 7D with a general shape that is circular at least in part.

Thus, by virtue of the invention, the rear structure 6 of the reflector 1, comprising at least one structural portion 7A, 7B, 7C, 7D that is circular, is not of the usual completely polygonal type. The use of a circular structural portion 7A, 7B, 7C, 7D of this kind has a number of advantages which are detailed below.

In a first embodiment shown in FIGS. 1 and 2, the rear structure 6 of the reflector 1 comprises a single structural portion 7A, this structural portion 7A having a general shape that is completely circular.

This structural portion 7A is arranged concentrically in relation to the shell 2 which is of a parabolic type and therefore circular in shape in a plan view, as shown in FIG. 2.

The shell 2 therefore has a paraboloid structure, the centre O (situated on an axis X-X) of which is shown in particular in FIG. 2. In addition, the structural portion 7A of said rear structure 6 is arranged on the rear surface 5 of the shell 2 so as to be situated, at all points, at a substantially constant distance from said rear surface 5.

In order to do this, the reflector 1 also has a plurality of fixing elements 8, detailed below, which are arranged between the rear surface 5 of the shell 2 and a surface facing said rear structure 6. These fixing elements 8 are intended to secure the reinforcement system 4 to the shell 2.

The fixing elements 8 are distributed, preferably uniformly, around the periphery of the rear structure 6.

The rear structure 6 is therefore placed in a plane above the shell 2, on the side of its rear surface 5, and allows the (generally parabolic) shape of the reflector 1 to be followed. Thus, the reflector 1 is geometrically very compact.

The fixing elements 8 may correspond to any mechanical element, in particular an angle plate, which is for example T-shaped or L-shaped, allowing the rear structure 6 to be fixed remotely to the rear surface 5 of the shell 2 and having flexibility.

The preferred positioning for a fixing element 8 is to arrange it radially in relation to the (rounded) rear surface 5 of the shell 2. This creates a maximum degree of flexibility between the shell 2 and the rear structure 6. By virtue of the circular shape of the rear structure 6, said rear structure is able to follow the shape of the shell 2, and therefore over the whole of the circular portion, the fixing elements 8 can be arranged radially without requiring, for example, angle wedges, which is advantageous, in particular, for reasons of ease of fitting and weight reduction.

Furthermore, in another embodiment shown in FIG. 3, the rear structure 6 comprises a plurality of structural portions 7B and 7C. These structural portions 7B and 7C have general shapes that are circular, but of different diameters d1 and d2, respectively.

These structural portions 7B and 7C are arranged concentrically in relation to one another, and also in relation to the shell 2.

The rear structure 6 has, in addition, connecting tubes 9, preferably rectilinear connecting tubes, which join together the structural portions 7B and 7C, in particular in order to improve the mechanical strength. Preferably, these connecting tubes 9 are arranged radially in relation to the structural portions 7B and 7C.

An assembly of this nature of rectilinear (or straight) connecting tubes 9 and of circular tubes (structural portions) may be used where the rear structure is made up of multiple concentric circular structural portions and where rectilinear (preferably radial) connecting tubes 9 are used to connect the circular portions to one another.

The rear structure 6 may therefore have, in particular, one or more than one completely circular (rear) structural portion, as shown in FIG. 2 (showing a single circular structural portion 7A), or it may have a combination of circular rear structural portions and rectilinear connecting tubes, as shown in FIG. 3.

The use of a rear structure 6 with one or more than one circular structural portion allows a shell edge length D (relative to the radially outer edge 2A of the shell 2) to be obtained that is constant over the whole of the perimeter of the shell 2, whether for the single structural portion 7A as in the example shown in FIG. 2, or for the radially outermost structural portion 7B (of the rear structure 6) as in the example shown in FIG. 3. The diameter of this rear structure 7A, 7B can therefore be chosen so as to ensure that the shell edge (or free edge) length D is optimal, which improves, in particular, the mechanical performance of the reflector 1 in comparison with a standard architecture with a polygonal rear structure.

The optimal length of the free edge depends on the material and the thickness of the shell 2, and also on the general design of the reflector 1. By way of illustration, for an antenna of a large size, the optimal length of the free edge may be situated between 5 cm and 70 cm. A free edge such as this allows the mechanical energy experienced at the time of launch to be dissipated, but it is not too long, so as not to lead to large movements of the shell edge.

The use of a circular shape for the rear structure 6 also allows a symmetry of revolution of the reflector 1 to be maintained, which reduces the regions of concentration of stresses (which are regions of potential weakness of the reflector), and improves all the performance characteristics of the reflector 1. Thus, the thermal deformation performance of the reflector 1 is multiplied tenfold (the deformations are ten times lower) in comparison with a similar reflector with a polygonal rear structure.

Furthermore, in a second embodiment, the structural portion 7D of said rear structure 6 has a mixed general shape 10 comprising at least one circular portion 11, 12 and at least one polygonal (or rectilinear) portion 13, 14, as shown in FIG. 4.

In the particular embodiment shown in FIG. 4, this mixed general shape 10 is a truncated circular shape, comprising alternate circular portions (or sections) 11 and 12 and rectilinear portions (or sections) 13 and 14. Said shape also has a rectilinear section 15 joining together the two rectilinear portions 13 and 14.

In this second embodiment, as in the first embodiment, the reflector 1 likewise has a plurality of fixing elements (not shown) that are arranged between the rear surface 5 of the shell 2 and the surface facing the rear structure 6.

There is an optimal length for the fixing elements 8. This is because a fixing element that is too long is more susceptible to buckling and its mechanical strength (and that of the reflector) is reduced, and a fixing element that is too short allows insufficient flexibility between the structure and the shell. In addition, a fixing element that is too short results in losses of mechanical performance in the strength of the joint at the foot of the fixing element. By way of illustration, the optimal length for a fixing element 8 is situated between 3 cm and 40 cm. This optimal length is dependent on the features of the fixing element, such as the material of which the fixing element is made, its width, its thickness, the type of joint between the fixing element and the shell, and the type of joint between the element and the rear structure.

Furthermore, whatever the embodiment concerned, the rear structure 6 comprises, preferably, tubes made of a carbon-based composite material, which ensure that this rear structure has mechanical strength and stiffness, and a high degree of inertia, in order to obtain good performance characteristics for the whole reflector. These tubes may have transverse sections with different shapes, for example an ellipse or preferably a circle, or sections with polygonal shapes, in particular rectangular or square shapes.

Thus, each circular structural portion may be a complete torus or multiple portions of a torus. The torus portions may be fitted to one another or may be separate.

The shape of the rear structure 6 may depend, in particular, on the size of the shell 2 and on the position of interfaces with the satellite so as to ensure that the shell 2 is held at points distributed over its surface.

Furthermore, the present invention may be applied to reflectors provided with different types of shell, and in particular:
to reflectors of which the shell is parabolic, the shape of the shell being a paraboloid of revolution; and
to reflectors of which the shell has a local shaping.

The reflector 1, as described above on the basis of several different embodiments, therefore comprises a rear structure 6 that is circular at least in part and not completely polygonal. The use of a rear structure 6 of this kind (circular) therefore has a number of advantages, and in particular the following advantages:
the rear structure 6 allows the production of a compact reflector 1, with a rear structure 6 arranged everywhere as close as possible to the shell 2. In addition, on the circular portion, a constant distance can be provided between the rear structure 6 and the shell 2. This distance may be chosen as being equal to the optimal length of the fixing elements 8, which improves the mechanical performance characteristics of the reflector 1 in comparison with the use of a polygonal structure;
the fixing elements 8 fitted to the rear structure 6 may be arranged radially, which is their optimal position and does not require additional angle wedges; and
the rear structure 6 is arranged, on the circular portion, at the same distance from the edge 2A of the shell 2. The use of a completely circular structure allows a shell edge length D to be obtained that is constant over the whole of the perimeter of the shell 2, and which may be chosen so that it is equal to an optimal length.

The method of manufacture of the reflector 1, as described above, is as follows. The rear structure 6 (circular at least in part) is manufactured from carbon-based composite material. By way of illustration, it may be made by drape-forming pre-impregnated layers, by deposition of dry layers, then by liquid resin moulding by low-pressure injection (resin transfer moulding, RTM) or by infusion, then by polymerisation of the resin.

As an example, a cannular toric rear structure 6 is manufactured by using a toric mould and drape-forming composite layers over the mould.

The shell 2 of the reflector 1 is manufactured in the usual manner. In addition, the operations to assemble the rear structure 6 and to fix it to the shell 2 use methods identical to those used for standard reflectors.

1. An antenna reflector, in particular for a spacecraft and especially for a satellite, said reflector comprising a shell provided with a first surface that is reflective, and a reinforcement system which is arranged on a second surface of the shell, opposite said first surface, and a rear structure comprising at least one structural portion with a general shape that is circular at least in part,
wherein a plurality of fixing elements is arranged between the second surface of the shell and a surface facing said rear structure said fixing elements securing the reinforcement system to the shell, said fixing elements being arranged radially on said second surface of the shell.

2. The antenna reflector according to claim 1,
wherein at least one structural portion of said rear structure has a general shape that is completely circular.

3. The antenna reflector according to claim 2,
wherein said rear structure comprises a plurality of structural portions with general shapes that are circular, and of different diameters.

4. The antenna reflector according to claim 2,
wherein said shell has a paraboloid structure, and said at least one structural portion of said rear structure is arranged on the second surface of the shell wherein a set of fixing elements hold the rear structure at a substantially constant distance from said second surface.

5. The antenna reflector according to claim 4,
wherein the paraboloid structure is of a type with local shaping.

6. The antenna reflector according to claim 1,
wherein said at least one structural portion of said rear structure has a mixed general shape, comprising at least one polygonal portion and at least one circular portion.

7. The antenna reflector according to claim 6,
wherein said mixed general shape is a truncated circular shape.

8. The antenna reflector according to claim 1,
wherein said fixing elements have an optimal length that depends on the fixing element concerned, on the type of joint between the fixing element and the shell and the type of joint between the fixing element and the rear structure.

9. The antenna reflector according to claim 1,
characterised in that said wherein at least one structural portion of the rear structure comprises at least one torus.

10. The antenna reflector according to claim 9,
wherein the torus is produced as a single part.

11. The antenna reflector according to claim 9,
wherein the torus is produced as a plurality of elements assembled together.

12. The antenna reflector according to claim 1,
wherein said rear structure is made of composite material.

13. A spacecraft, in particular a satellite,
wherein it has at least one antenna reflector according to claim 1.

14. The antenna reflector according to claim 4, wherein the paraboloid structure is of a type without local shaping.
